(19) United States
(12) Patent Application Publication
(10) Pub. No.: US 2010/0190101 A1
(43) Pub. Date: Jul. 29, 2010

(54) DEVELOPER, IMAGE FORMING APPARATUS AND IMAGE FORMING METHOD

(75) Inventor: Shoko Shimmura, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/695,253

(22) Filed: Jan. 28, 2010

Related U.S. Application Data
(60) Provisional application No. 61/148,173, filed on Jan. 29, 2009.

(51) Int. Cl. G03G 13/16; G03G 9/083; G03G 15/08

(52) U.S. Cl. 430/111.41; 399/252; 430/125.3

(57) ABSTRACT

There is provided a technique capable of reducing a transfer residual ratio of a toner to an image carrier. A developer includes a magnetic particle, and a toner particle charged by the magnetic particle, and when a relation between an adhesion force F of the toner particle to an image carrier of an image forming apparatus and a square of a charge amount q of the toner particle is represented by a linear function approximate expression of F=K×q²+F₀ based on a particle size distribution of the toner particle, a value of a proportional constant K of the square of the charge amount q of the toner particle and a value of a non-electrostatic adhesion force F₀ satisfy a specified relation.

### CROSS-REFERENCE TO RELATED APPLICATION

This application is based upon and claims the benefit of priority from: U.S. provisional application 61/148, 173, filed on Jan. 29, 2009; the entire contents of each of which are incorporated herein by reference.

### TECHNICAL FIELD

The present invention relates to a developer, and relates to an image forming technique when an image is formed by an electrophotographic system copying machine, printer or the like.

### BACKGROUND

In general, in an image forming apparatus using an electrophotographic system, a toner particle is conveyed through a conveyance medium, for example, an electrostatic latent image carrier (also called an image carrier) such as a photoreceptor or an intermediate transfer body such as a transfer belt, and is adhered to a desired position on a final transfer medium (hereinafter simply referred to as a sheet) such as paper. Then, the toner particle is pressed by a heat roller or the like and is fixed to the sheet, and an image is formed on the sheet.

Here, in the conveyance of toner particles from the image carrier to the intermediate transfer body or the final transfer medium, it is hitherto known that part of the toner particles is not conveyed but remains on the image carrier. In order to form a higher quality image, it is desirable that the amount of the toner which is not transferred but remains can be reduced.

Besides, in a tandem type image forming apparatus in which image forming units including plural image carriers are arranged, there is a case where an image carrier which is disposed at a latter stage and conveys a toner image of different color contacts with an already transferred toner image, and an already transferred toner particle is reversely transferred to the image carrier for the different color.

Then, in order to solve these problems, a technique to control the adhesion force of the toner particle to the image carrier or the intermediate transfer body is proposed.

For example, a technique is proposed in which the relation between the volume average particle size of toner particles, average adhesion force and average charge amount is made to fall within a specified range, so that the adhesion force is controlled (JP-A-2008-020906). Besides, a technique is proposed in which in order to obtain a stable high transfer ratio, the relation of the average electrostatic adhesion force to the charge amount is defined, and even if the charge amount is changed, the amount of change of transfer electric field can be reduced (JP-A-2007-235885).

However, there is a demand for a developer in which the number of remaining toner particles can be further reduced, and the reverse transfer can be more certainly prevented.

### SUMMARY

According to an aspect of the invention, a developer includes a magnetic particle, and a toner particle charged by the magnetic particle, and when a relation between an adhesion force F of the toner particle to an image carrier of an image forming apparatus and a square of a charge amount q of the toner particle is represented by a linear function approximate expression of F=K×q²+F₀ based on a particle size distribution of the toner particle, a value of a proportional constant K of the square of the charge amount q of the toner particle and a value of a non-electrostatic adhesion force F₀ satisfy a following relation.

0<K≦2×10²² i)

0<F₀≦4.0×10⁻⁸ ii)

K<−5×10²⁹×F₀+2×10²² iii)

According to another aspect of the invention, an image forming apparatus includes an image carrier on which an electrostatic latent image is formed, a developer containing section to contain a developer having a toner particle in which when a relation between an adhesion force F to the image carrier and a square of a charge amount q is represented by a linear function approximate expression of F=K×q²+F₀ based on a particle size distribution, a value of a proportional constant K of the square of the charge amount q of the toner particle and a value of a non-electrostatic adhesion force F₀ satisfy a following relation, and a magnetic particle to charge the toner particle, and a developing section which causes the toner particle of the developer contained in the developer containing section to adhere to the electrostatic latent image formed on the image carrier, and develops the electrostatic latent image to form a toner image on the image carrier.

0<K≦2×10²² i)

0<F₀≦4.0×10⁻⁸ ii)

K<−5×10²⁹×F₀+2×10²² iii)

According to another aspect of the invention, an image forming method includes causing a photoreceptor or a conveyance medium to support a toner particle in which when a relation between an adhesion force F of the toner particle to an image carrier of an image forming apparatus and a square of a charge amount q of the toner particle is represented by a linear function approximate expression of F=K×q²+F₀ based on a particle size distribution, a value of a proportional constant K of the square of the charge amount q of the toner particle and a value of a non-electrostatic adhesion force F₀ satisfy a following relation, and forming an image by transferring the toner particle supported on the photoreceptor or the conveyance medium onto a sheet.

0<K≦2×10²² i)

0<F₀≦4.0×10⁻⁸ ii)

K<−5×10²⁹×F₀+2×10²² iii)

### DESCRIPTION OF THE DRAWINGS

FIG. 1 is a perspective view showing a sample set for measuring adhesion force F of a toner particle in an embodiment of the invention.

FIG. 2 is a sectional view showing a cell for measuring an average adhesion amount of the toner particle in the embodiment of the invention.

FIG. 3 is a perspective view showing an angle roller for measuring the average adhesion amount of the toner particle in the embodiment of the invention.

FIG. 4 is a sectional view showing the angle roller for measuring the average adhesion amount of the toner particle in the embodiment of the invention.

FIG. 5 is a graph showing a particle size distribution of the toner particle in the embodiment of the invention.

FIG. 6 is a graph showing a distribution of the adhesion force F of the toner particle at number frequency D50 in the embodiment of the invention.

FIG. 7 is a graph showing a distribution of the square of a charge amount q of the toner particle at number frequency D50 in the embodiment of the invention.

FIG. 8 is a graph showing a relation between the square of the charge amount q and the adhesion force F of the toner particle in the embodiment of the invention.

FIG. 9 is a graph showing a relation between the square of a charge amount q and an adhesion force F of a toner particle in a comparative example.

FIG. 10 is a graph showing a relation between the square of a charge amount q and an adhesion force F of a toner particle in a comparative example.

FIG. 11 is a graph showing a relation between a transfer residual ratio and non-electrostatic adhesion force F₀ in the example and the comparative example.

FIG. 12 is a graph showing a relation between the transfer residual ratio and a proportional constant K of the square of the charge amount q in the example and the comparative example.

FIG. 13 is a graph showing a relation between non-electrostatic adhesion force F₀ and the proportional constant K of the square of the charge amount q in the example and the comparative example.

FIG. 14 is a view showing the outline of an image forming apparatus of the embodiment of the invention.

FIG. 15 is a view showing the outline of the image forming apparatus of the embodiment of the invention.

FIG. 16 is a view showing the outline of an image forming apparatus of the embodiment of the invention.

FIG. 17 is a view showing the outline of an image forming apparatus of the embodiment of the invention.

### DETAILED DESCRIPTION

Hereinafter, an embodiment of the invention will be described with reference to the drawings.

A developer of the embodiment includes a magnetic particle and a toner particle (also simply called a toner) charged by the magnetic particle. In the developer of the embodiment, when a relation between an adhesion force F of the toner particle to an image carrier of an image forming apparatus and the square of a charge amount q of the toner particle is represented by a linear function approximate expression of F=K×q²+F₀ based on a particle size distribution of the toner particle, a value of a proportional constant K of the square of the charge amount q of the toner particle and a value of a non-electrostatic adhesion force F₀ satisfy a following relation.

0<K≦2×10²² i)

0<F₀≦4.0×10⁻⁸ ii)

K<−5×10²⁹×F₀+2×10²² iii)

In the related art, it is proposed that the average adhesion force of the toner and the average particle size are controlled, and the adhesion force to the image carrier is controlled to fall within the specified range, so that the transfer characteristic of the toner is improved. Incidentally, in the present specification, the term “transfer characteristic” is used as a generic term for a property about remaining of toner on an image carrier and a property about transfer residual.

However, the present inventor noticed that even when the average adhesion force of the toner and the average particle size were controlled, there was a case where a part of the toner was not transferred to an image carrier but remained, or reverse transfer to the image carrier occurred.

Then, as a result of earnest investigation, the present inventor presumed that the occurrence of the toner remaining on the image carrier or the occurrence of the reverse transfer to the image carrier was due to a particle having such a characteristic that the adhesion force or the particle size was far away from the average. In this case, in order to further improve the transfer characteristic, it is not sufficient only to control the average adhesion force of the toner and the average particle size thereof.

Here, since the toner particle is an aggregation of fine particles with an average particle size of 3 to 10 μm in which various components such as binding resin, coloring agent, fixing auxiliary agent, charging auxiliary agent, and fluidity control agent are mixed, it is difficult to make the particle size and the component ratio strictly monodisperse. Especially, in the case of a two-component developer, the toner particle is mixed with a carrier particle at a constant weight ratio and is agitated to be charged by friction. Thus, since it is impossible to individually control the contact and the friction strength between the toner particle and the carrier particle, it is further difficult to make the charge amount distribution strictly monodisperse. Accordingly, with respect to the toner particle, a certain degree of distribution exists in each of the particle size, the component ratio and the charge amount.

Here, the present inventor conceived that the transfer characteristic was improved by narrowing the transfer electric field distribution in toner particles having various particle sizes and by causing the reaction characteristic to the electric field to become constant.

Next, with respect to the toner particles of various compositions, the present inventor expressed a relation between an adhesion force F to an image carrier and the square of a charge amount q by a linear function approximate expression of F=K×q²+F₀ based on the particle size distribution of the toner particles, and measured the transfer residual ratio of the toner particles. From the analysis of the result, the inventor found that when the proportional constant K of the square of the charge amount q and the non-electrostatic adhesion force F₀ were controlled to satisfy specific parameters, the transfer characteristic could be improved, and the present invention was made.

The setting of the parameters of the proportional constant K of the square of the charge amount q and the non-electrostatic adhesion force F₀ according to the embodiment will be described in more detail.

As described above, the present inventor conceived that the transfer characteristic was improved by narrowing the transfer electric field distribution in toner particles having various particle sizes and by causing the reaction characteristic to the electric field to become constant.

Here, the transfer electric field E means the driving force to move the toner particle from the image carrier to the transfer medium. That is, when the driving force Eq by the transfer electric field becomes larger than the adhesion force F of the toner particle, the particle can be transferred from the image carrier to the transfer medium.

The transfer electric field E can be represented by the following expression.

E=F/q [V/m]

In the expression, F denotes the adhesion force of the toner particle to the image carrier, and q denote the charge amount of the toner particle. Besides, the adhesion force F can be represented by the following expression.

F=K×q²+F₀

Where, K denotes the proportional constant of the square of the charge amount q of the toner particle, and K×q² denotes the electrostatic adhesion force. On the other hand, F₀ denotes the adhesion force when the particle charge amount is 0, that is, the non-electrostatic adhesion force. The non-electrostatic adhesion force includes mainly van der Waals force and liquid cross-linking force (hydration force). Almost all components used for the toner particle are hydrophobic in order to prevent the charge property to the utmost from changing due to environmental humidity. Accordingly, it appears that the liquid cross-linking force is very small. When an objective particle is a true sphere having a smooth and uniform material plane, the van der Waals force is the force proportional to the radius thereof. However, when the toner particle is the true sphere, it passes through a cleaning blade, and accordingly, a different form is desirable. Further, since inorganic and/or organic fine particles are externally added to the surface for the purpose of improving the fluidity, the surface is not quite smooth. Further, since the mother particle includes the binding resin, coloring agent, fixing auxiliary agent, charging auxiliary agent and the like, those components are exposed on the surface of the particle, or the plural kinds of external additives do not necessarily cover the surface of the particle completely. As factors to influence the van der Waals force, in addition to the particle size and the surface property, there is a Hamaker coefficient intrinsic to the material. The van der Waals force varies also according to the material of the surface which actually contacts with the photoreceptor. Thus, it is very difficult to produce a particle group in which the van der Waals force is controlled by calculation. On the other hand, the electrostatic adhesion force is proportional to the square of the electric charge when the electric charge is assumed to be a point charge. However, the electrostatic adhesion force of the toner particle is 10 to 100 times larger than the value calculated on the assumption that the electric charge is the point charge.

Accordingly, in order to narrow the transfer electric field distribution, it is sufficient if the distribution of the adhesion force F is narrowed.

Here, the inventor investigated the relation between the distribution of the adhesion force F and the transfer residual ratio. Specifically, first, with respect to toner particles different in structure, the adhesion force for each particle size and the charge amount for each particle size were measured. In other words, the adhesion force and the charge amount corresponding to a specific particle size were obtained. Next, based on the obtained values of the adhesion force and the charge amount, the expression of F=K×q²+F₀ representing the adhesion force F was obtained as the linear function approximate expression. Besides, the transfer residual ratio of the toner particle used for the measurement was measured.

Then, based on the analysis on K and F₀ and the transfer residual ratio, parameters of the proportional constant K of the square of the charge amount q and the non-electrostatic adhesion force F₀ according to the embodiment were configured.

Incidentally, production of the toner particles used for the measurement and the structure thereof will be described in after-mentioned examples.

### (Measurement of the Distribution of the Charge Amount q for Each Particle Size, and Measurement of the Adhesion Force F for Each Particle Size)

The measurement of the distribution of the charge amount q for each particle size of the toner particle is not particularly limited, and a skilled person in the art can suitably select and perform the measurement. For example, a charge amount distribution measuring apparatus can be used to perform the measurement. As the charge amount distribution measuring apparatus, E-spart analyzer made by Hosokawa Micron Corporation can be exemplified. The measurement relating to the setting of the parameter was also performed by using the E-spart analyzer. In the measurement of the charge amount distribution, it is preferable that the amount of development toner on the photoreceptor (image carrier) is adjusted to be not large than the amount equivalent to about one layer. More specifically, since the particle size of the toner varies according to the kind thereof, it is preferable to satisfy the relation represented by the following expression, and further, it is more preferable that the toner amount is made 150 to 300 μg/cm². Incidentally, P in the expression relating to the toner amount on the photoreceptor denotes a void ratio of the toner, and P=0.3 to 0.6 is preferable, and P=0.4 to 0.5 is more preferable.

toner amount<(4/3) toner 50% volume average radius×specific gravity×P(T)

Also in the measurement relating to the setting of the parameter, the amount of development toner on the photoreceptor was made 150 to 300 μg/cm² according to the particle size of the toner.

Besides, in the measurement of the charge amount distribution, it is preferable that the number of measurement particles is 15000 or more. Specifically, the number of measurement particles was made 18000.

Besides, the measurement method of the distribution of the adhesion force F for each particle size of the toner particle is not particularly limited. For example, the toner of the amount equivalent to about one layer is adhered to an image carrier sheet by development, the rotation speed of an ultra-centrifugal machine is gradually increased and the particle size distribution of the toner separated from the image carrier sheet at each time can be measured by image processing. The measurement of the adhesion force distribution for each particle size of the toner particle at the setting of the parameters of the embodiment was also performed by the method. Incidentally, in the present specification, the centrifugal force applied to the toner particle by the rotation of the ultra-centrifugal machine is regarded as the adhesion force F of the toner particle to the photoreceptor, which is separated from the image carrier sheet at the rotation speed. In the measurement of the adhesion force, it is preferable that the rotation speed is increased from 10000 rpm to 100000 rpm, and 15000 or more particles are measured.

When the distribution of the adhesion force F is obtained, the adhesion force F can be obtained in conformity with a method disclosed in, for example, JP-A-2002-328484. JP-A-2002-328484 proposes a method of calculating from the centrifugal force when the toner particle is separated from an adhesion target material by using a centrifugal separator. In the measurement of the distribution of the adhesion force F for each particle size of the toner particle when the parameters are set, the same centrifugal separator, the same rotor and the same cell as those introduced in JP-A-2002-328484 were used. Specifically, as the centrifugal separator, ultra-centrifugal machine CP100MX for separation made by Hitach Koki Co., Ltd. was used. Besides, as the rotor, Angle Rotor P100AT2 was used. Besides, as the cell, the cell produced for powder adhesion force measurement was used.

For the measurement, an image carrier sheet (photoconductive sheet) having a surface protective layer equivalent to an image carrier of a measurement object of the adhesion force F was prepared. Instead thereof, after toner is adhered to the photoreceptor itself, it may be cut into a suitable size and is used.

Incidentally, it is desirable that the surface protective layer is made of the same material as the surface protective layer of the image carrier. However, since it is said that difference in adhesion force due to the material of an adhesion target material is small as compared with the difference in shape (surface roughness etc.), toner charge amount, environment temperature and humidity, and the like, it is not necessary that they are strictly the identical material. In order to reproduce the toner adhesion to the image carrier, a CGL layer or a CTL layer may be laminated similarly to the image carrier.

The image carrier sheet was wound around an aluminum element tube, the photoconductive layer was grounded to GND, and was set at the photoconductive drum position, and toner was developed and adhered to the surface similarly to the image formation. It is preferable that the adhesion amount satisfies the relation of the expression (T) so as to form one toner particle layer or less similarly to the case of the measurement of the charge amount distribution, and it is more preferable that the toner amount is made 150 to 300 μg/cm². Also in the measurement relating to the setting of the parameters, the amount of adhered toner was made 150 to 300 μg/cm² according to the toner particle size.

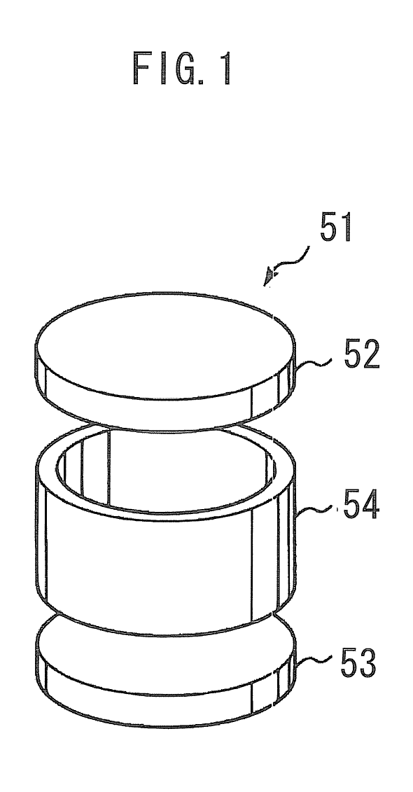

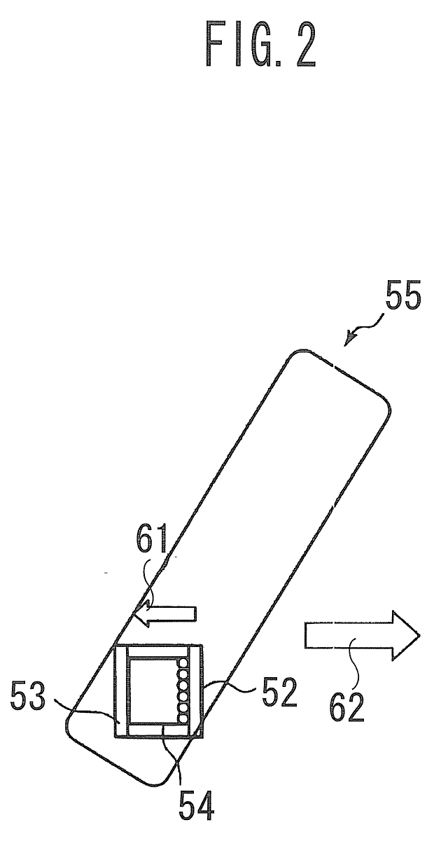

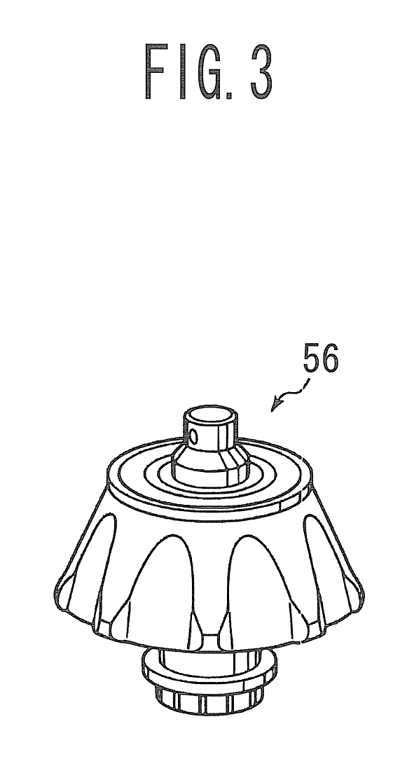

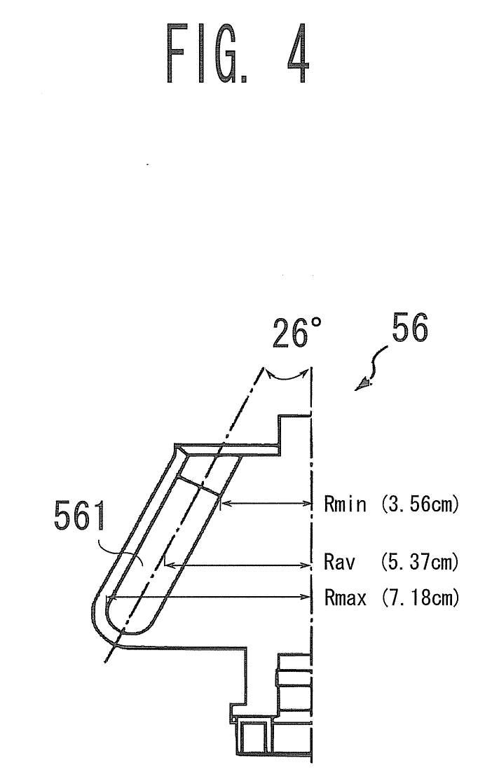

Next, the image carrier sheet to which the toner was adhered was placed on a sample set. As shown in FIG. 1, a sample set 51 includes a plate 52, a plate 53, and a cylindrical spacer 54. The outer periphery diameter of each of the plate 52, the plate 53 and the spacer 54 is 7 mm, the thickness of the spacer 54 is 1 mm, and the height is 3 mm. In the setting to the sample set, the image carrier sheet to which the toner is adhered is cut into the size of the plate 52, and is bonded to the side, which contacts with the spacer 54, of the plate 52 by a double-faced tape. Next, as shown in FIG. 2, the plate 52, the spacer 54 and the plate 53 are set in a cell 55 in this order, and next, the cell 55 is set in a cell insertion portion 561 shown in FIG. 4 in an angle rotor 56 of FIG. 3. Next, the angle rotor 56 is mounted to a not-shown ultra-centrifugal machine.

After the ultra-centrifugal machine is rotated at 10000 rpm, the plate 53 is extracted, the adhered toner particle is photographed by a CCD camera and is converted into an electronic image. In the photographing, for example, at such a magnification that one pixel is 0.1 to 0.4 μm, four areas each having 1200×1600 pixels are photographed. Specifically, four areas each having 1200×1600 pixels are photographed at such a magnification that one pixel is 0.18 μm. After the photographing, the adhered toner is bonded to a mending tape, and is removed from the sample plate. The tape to which the toner is adhered is bonded to a white paper, and the reflection density is measured from above by Macbeth densitometer, and is converted into the toner amount per unit volume by a previously prepared calibration expression of reflection density and toner amount.

Next, the sample plate 52, the plate 53 from which the adhered toner is removed, and the spacer 54 are again combined and are set in the angle rotor 56, are extracted after the ultra-centrifugal machine is rotated at 15000 rpm, and the amount of toner adhered to the plate 53 is photographed. This operation is repeated up to 100000 rpm while the rotation speed is increased.

The particle size distribution of the adhered particles at respective rotation speeds is measured from the electronic images photographed at all rotation speeds, and the total amount of the measured particles at the respective rotation speeds (the volume is calculated from the particle size, the weight is calculated from the specific gravity, and the weight of all measured particles are summed) is corrected by the toner amount per unit volume based on the calibration expression of the reflection density and the toner amount. Then, the inverse operation is performed from the total toner amount after the correction and obtains the particle size distribution for every 0.5 μm of particle size.

Next, the centrifugal force (adhesion force F) applied to the toner is calculated at each particle size and each rotation speed. The centrifugal force can be calculated as described below.

First, the centrifugal acceleration RCF which is caused by the rotation of the rotor and is received by the sample set in the cell is obtained by the following expression.

RCF=1.118×10⁻⁵×r×N²×g

r: distance [cm] between the sample set position and the rotation center

N: rotation speed [rpm]

g: gravity acceleration [kgf]

Next, the centrifugal force (adhesion force F) [N] received by the toner particle is calculated based on the following expression when the weight of one toner particle is represented by m [kg per particle]

F=RCF×m

m=(4/3)π×r³×ρ

r: radius of true sphere [cm]

ρ: specific gravity of toner [kg/cm³]

Incidentally, the method is described in which the rotation speed of the ultra-centrifugal machine is increased every 5000 rpm from 10000 rpm. However, when the toner adhesion force is small, and 5% or more of all toners is peeled off from the photoconductive sample plate at 10000 rpm, the measurement must be started from a rotation speed lower than 10000 rpm, for example, 5000 rpm. When the amount of toner peeled at the respective rotation speeds is less than 5% of all toners even if the rotation speed is increased every 5000 rpm, the increased rotation speed may be made 10000 rpm and the measurement may be performed.

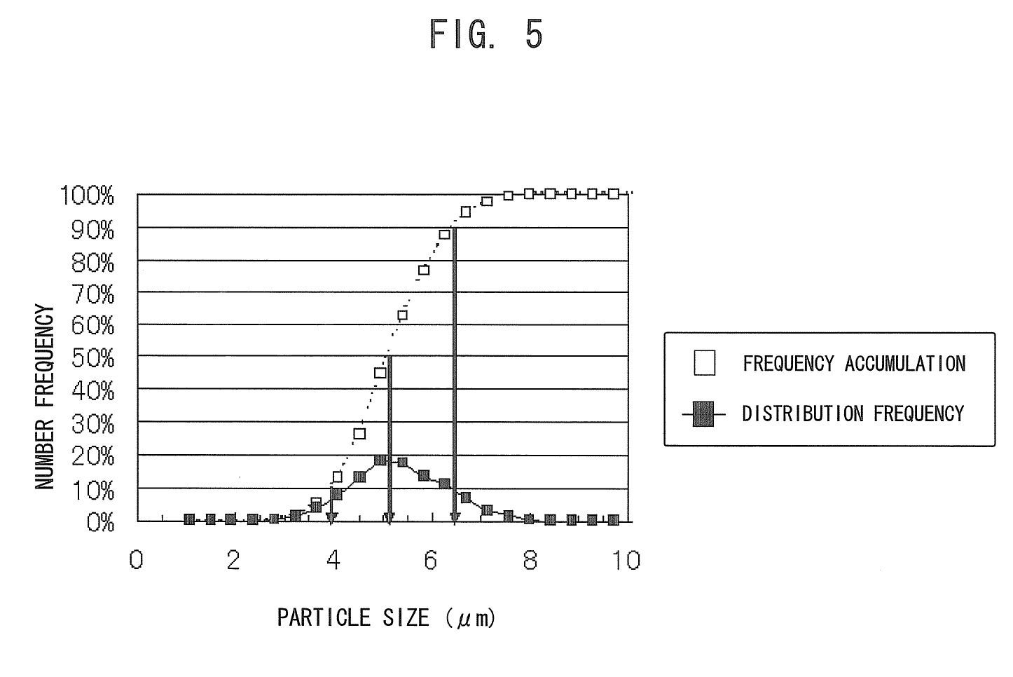

Besides, in the particle size distribution measurement result described above and the particle size distribution measurement result by the image processing, conversion is performed so that the particle size measurement values at number frequencies of 10%, 50% and 90% in these measurement results are coincident with the particle size measurement values at number frequencies of 10%, 50% and 90% in the particle size distribution separately obtained by a call counter. FIG. 5 shows the particle size distribution based on the call counter.

Next, the linear approximate expression F=K×q²+F₀ to represent the relation between the square of the charge amount q of the toner particle and the adhesion force F is obtained.

First, a graph showing the adhesion force distribution for each particle size, specifically, for the number frequencies of 10%, 50% and 90% is prepared from the obtained adhesion force distribution measurement result. Besides, a graph showing the charge amount distribution for each particle size, specifically, for the number frequencies of 10%, 50% and 90% is prepared from the obtained charge amount distribution measurement result. In the graph showing the distribution, the horizontal axis indicates the adhesion force F or the square of the charge amount q, and the vertical axis indicates accumulated weight ratio at each particle size.

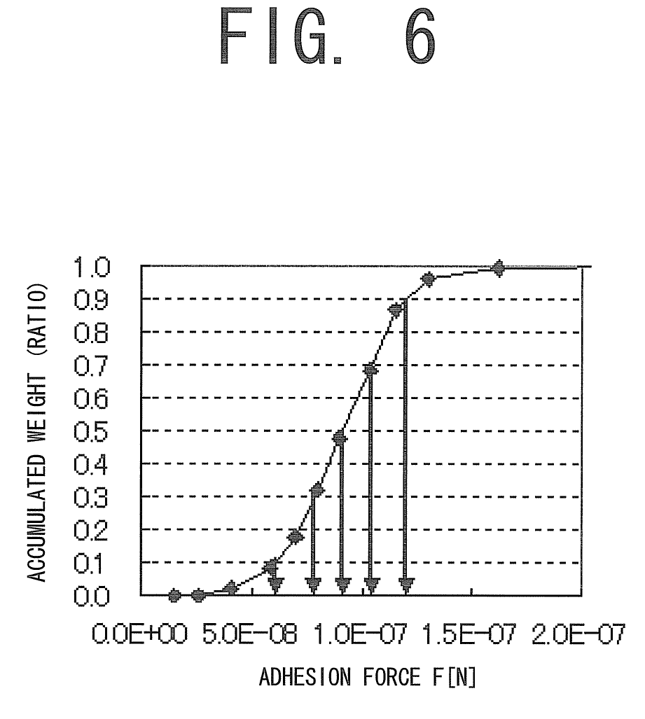

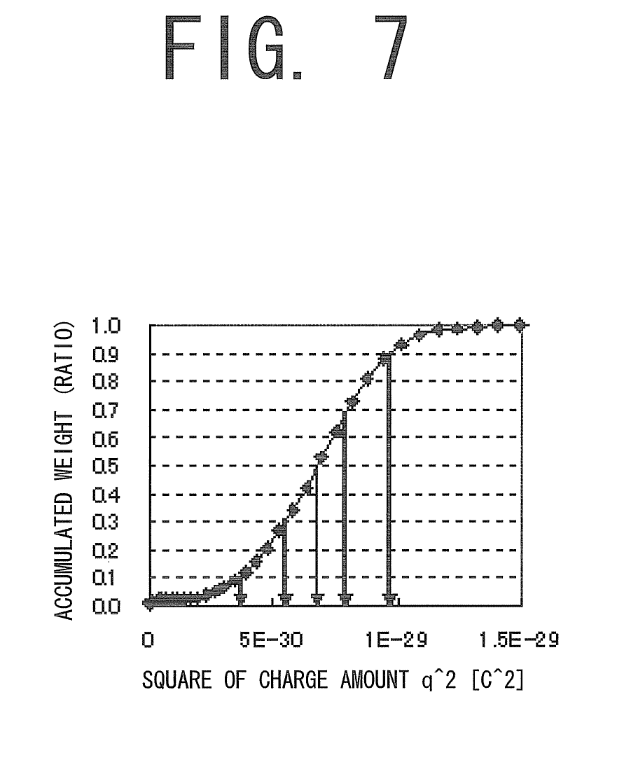

FIG. 6 shows a graph showing the distribution of the adhesion force F of the developer of after-mentioned example 1 having a particle size of 5.1 μm and a number frequency of 50%. FIG. 7 is a graph showing the distribution of the square of the charge amount q of the developer of the after-mentioned example 1 having the particle size of 5.1 μm and the number frequency of 50%.

A data (plot) group to obtain the linear approximate expression to represent the relation between the square of the charge amount q of the toner particle and the adhesion force F is acquired from the graph of the adhesion force F and the graph of the square of the charge amount q. Specifically, the values of the square of the charge amount q and the adhesion force F at the weight ratio accumulated values of 10%, 30%, 50%, 70% and 90% are read from the respective graphs of the number frequency of 10%, 50% or 90%.

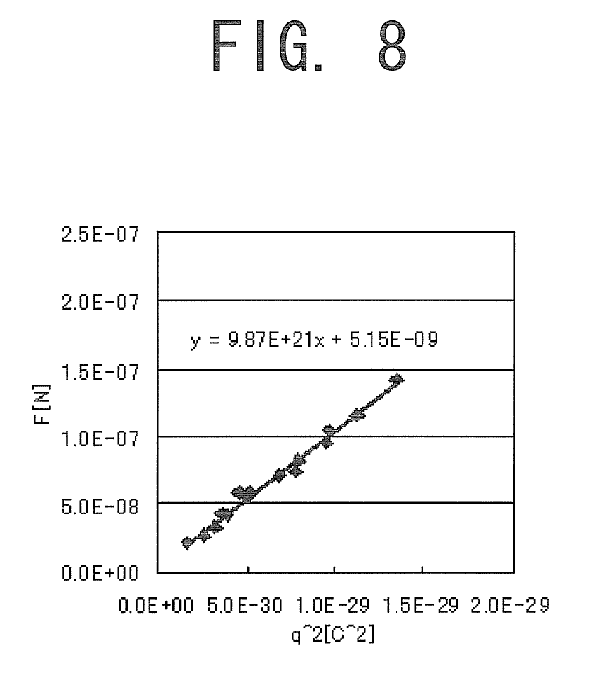

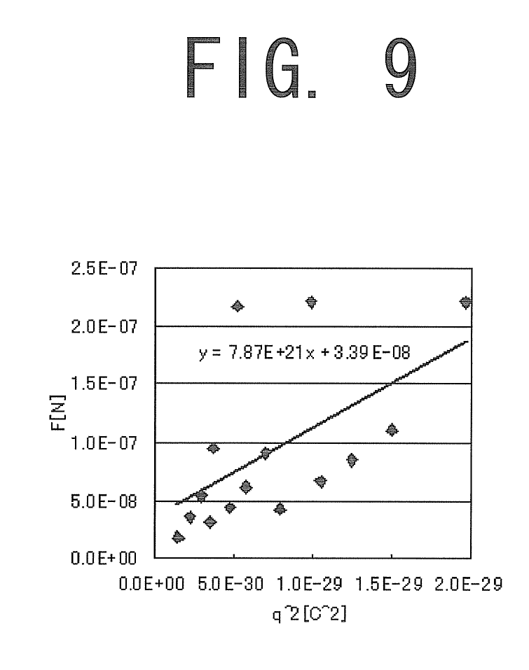

Next, the value of the square of the read charge amount q and the value of the adhesion force F are correlated and are plotted on the graph based on the number frequency and the weight ratio accumulated value. When the approximate expression is calculated from the plot of 15 points, with respect to the developer of the after-mentioned example 1, the expression of Y=9.87×10²¹×X+5.15×10⁻⁹ corresponding to a straight line as shown in FIG. 8 is obtained. Besides, with respect to the developer of after-mentioned comparative example 1, the expression of Y=7.87×10²¹×X+3.39×10⁻⁸ corresponding to a straight line as shown in FIG. 9 is obtained. Here, Y denotes the adhesion force F, and X denotes the square of the charge amount q.

In accordance with the method, F=K×q²+F₀ is obtained with respect to after-mentioned examples 1 to 7 and comparative examples 1 to 8, and the proportional constant K of the square of the charge amount q of the toner and the non-electrostatic adhesion force F₀ are obtained.

Incidentally, the approximate straight line is obtained based on the least square method. Specifically, when data (q²ᵢ, Fᵢ)=(Xᵢ, Yᵢ) is used for calculation, in the linear approximate expression F=a×q²+b=Y=a×X+b,

$$a = \frac{n \sum {X}_{i} {Y}_{i} - \sum {X}_{i} \sum {y}_{i}}{n \sum {X}_{i}^{2} - {( \sum {X}_{i} )}^{2}} b = \frac{\sum {X}_{i}^{2} \sum {Y}_{i} - \sum {X}_{i} \sum {X}_{i} {Y}_{i}}{n \sum {X}_{i}^{2} - {( \sum {X}_{i} )}^{2}}$$

and the calculation is performed.

### Where,

$$\sum = {\sum }_{i = 1}^{n}$$

Next, with respect to examples 1 to 7 and comparative examples 1 to 8, measurement of the transfer residual ratio is performed (the measurement method will be described later). As a result, as described later, the transfer residual ratio is 5% or less in all the examples, while the transfer residual ratio is larger than 5% in the comparative examples.

When the reverse transfer amount is 5 or less, even when the toner remaining on the image carrier is collected by the cleaning device and is discharged, it is not necessary to provide a special unit for toner conveyance in order to smoothly discharge the collected toner to a waste toner BOX. Besides, even when the capacity of the waste toner BOX can be suppressed to such a degree that the frequency of exchange is not troublesome for the user or service man, it can be set to a suitable size so that a specially large volume is not required in the machine. Besides, in the case of a recycle system in which the collected toner is returned into the developing apparatus and is reused, even when the powder characteristic and charging characteristic of the collected toner is slightly different from the non-used toner in the developing apparatus and selective development occurs slightly, when the transfer residual ratio is 5% or less, there hardly occurs a case where toner unsuitable for development is stored in the developing device and a desirable development characteristic is not obtained. Further, in the case of a cleanerless system (the details will be described later) in which a special toner collecting mechanism is not provided on a photoreceptor, and non-image part toner is collected in a development area simultaneously with the development, when the remaining transfer ratio is 5% or less, even if the charging and exposure process for the next image formation process is performed in the state where the toner remains on the photoreceptor, the remaining toner hardly inhibits the charging and exposure. Accordingly, it is preferable that the transfer residual ratio is 5% or less.

As a result of the investigation based on the results as stated above, the inventor found that in order to reduce the transfer residual ratio to, for example, 5% or less, it was necessary to control both K and F₀. Besides, the present inventor found that in the respective toner particles of the example in which the transfer residual ratio was 5% or less, the plots of 15 points in total were concentrated on an approximate straight line expressed by F=K×q²+F₀ or very closely thereto. Conceivably, that the data (plots) exist near the same straight line indicates that even when the particle sizes are different, the same F₀ and K are shared, and the same adhesion force characteristic is obtained. Accordingly, even if K is large, when F₀ is small, the transfer residual ratio can be reduced. On the other hand, even if F₀ is large, when K is small, the transfer residual ratio can be reduced. This is because the transfer electric field is determined by the sum of the electrostatic adhesion force and the non-electrostatic adhesion force as represented by the transfer electric field E=F/q=K×q+F₀/q. With respect to the toner including the particle having very large adhesion force and large transfer electric field, when the data of 15 sets are extracted, the data of the high adhesion force causes one or both of the slope (K) and the Y-intercept (F₀) of the approximate expression to have large values, and falls outside the scope of the invention. Also when the variation of the data of 15 sets is large, or also when K or F₀ is large although there is no variation, the phenomenon in which the transfer residual resultantly becomes large is the same.

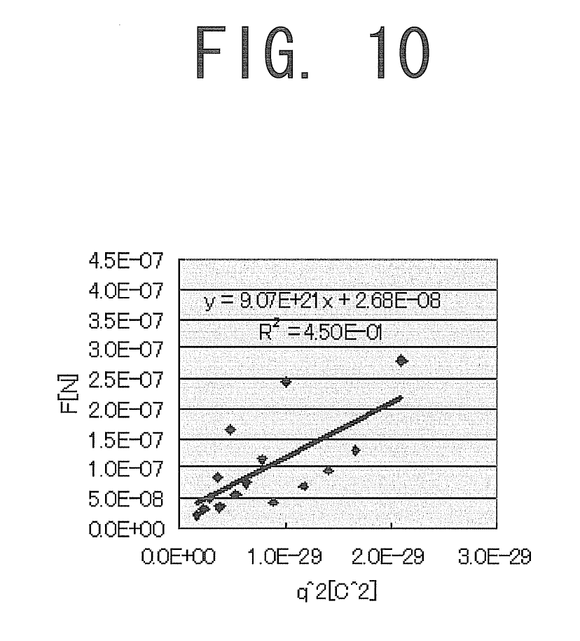

With respect to this point, a description will be made using comparative example 2 in which a toner particle having a large adhesion force relative to a charge amount is contained. FIG. 10 is a graph concerning the relation between the square of the charge amount q of the developer of comparative example 2 and the adhesion force F. In comparative example 2, as shown in FIG. 10, the correlation coefficient of a linear approximate straight line is very low. More specifically, as compared with the case where there is no plot of three points having large adhesion force and largely deviated from the approximate straight line, both the slope (K) and the Y-intercept (F₀) of the approximate expression are large. As stated above, the values of K and F₀ are values which include not only the relation between the adhesion force and the charge amount of most particles in the developer but also the degree of variation. Although it can not be completely said that they represent the relation between the adhesion force characteristic and the charge amount, there is a tendency that when the variation becomes large, both of or one of the slope (K) and the Y-intercept (F₀) of the linear straight line becomes extremely large.

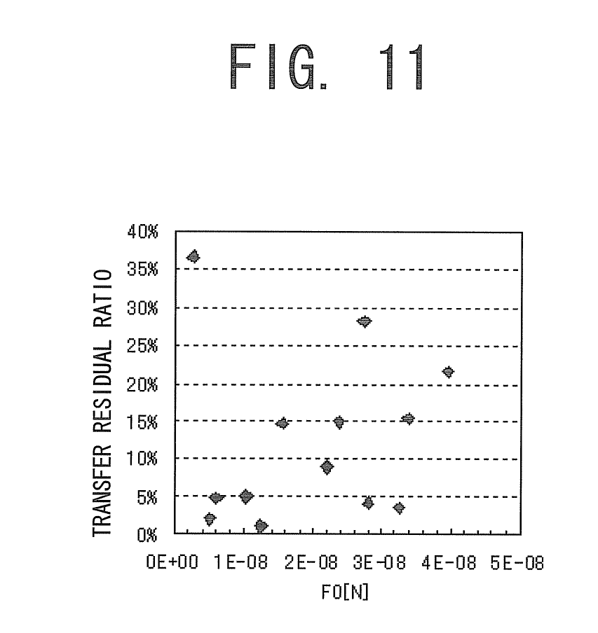

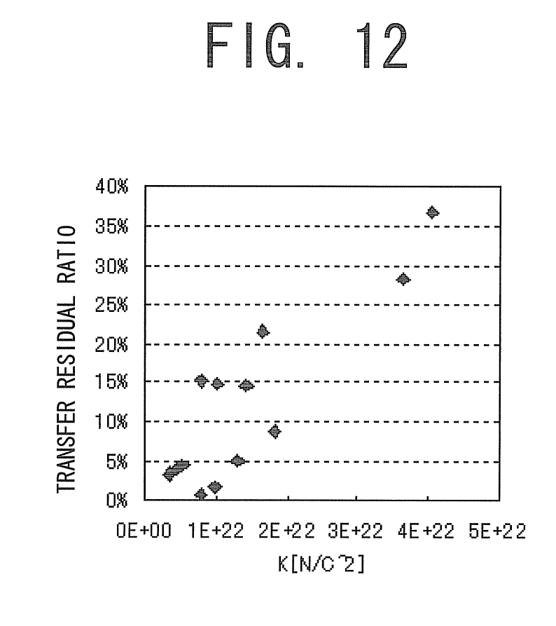

FIG. 11 shows the obtained relation between the transfer residual ratio and the non-electrostatic adhesion force F₀ concerning the examples and the comparative examples. Besides, FIG. 12 shows the obtained relation between the transfer residual ratio and the proportional constant K of the square of the charge amount q concerning the examples and the comparative examples.

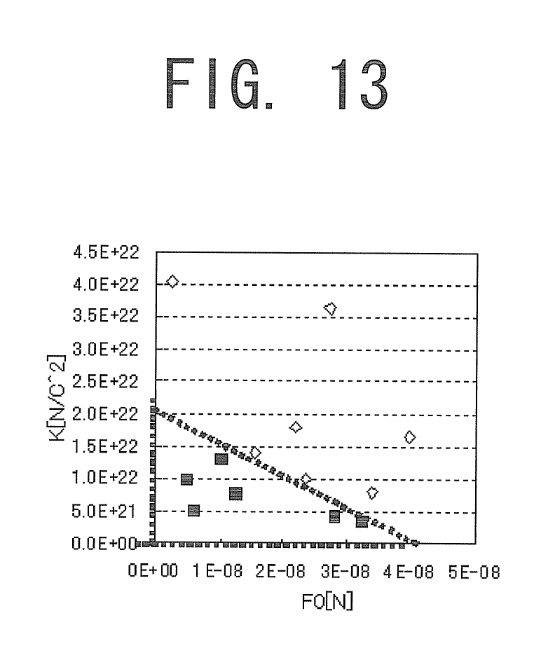

From the experimental results as stated above, the present inventor found that as shown in FIG. 13, when the relation of K<−5×10²⁹×F₀+2×10²² is satisfied, the transfer residual ratio is 5% or less and the excellent transfer efficiency is obtained.

Besides, with respect to the non-electrostatic adhesion force F₀, it is necessary that 0<F₀≦4.0×10⁻⁸ is established.

Although it can not theoretically occur that the value of F₀ becomes 0 or less, it can occur as the calculation value from actually measured data. However, the state where F₀ of the linear approximate expression becomes minus indicates that the toner particles having those data do not have the same adhesion force characteristic, and the variation in the adhesion force characteristic causes reduction of the transfer efficiency under the same transfer condition.

Besides, when F₀ is larger than 10⁻⁸ [N], the electric field required to transfer the toner particle becomes very large, an electric discharge occurs in a transfer area, and the toner receives the reverse polarity electric charge and can not be transferred.

This point will be specifically described. For example, the breakdown electric field (Ebk) as the Paschen discharge limit in the atmosphere is about 4.5×10⁷ [V/m], and the toner particle must be transferred by an electric field not higher than this. Here, F₀ denotes the magnitude of the minimum electric field required to transfer the toner, and the electric field (E) higher than that is actually required to be applied to the transfer area according to the electric charge amount (q) of the toner particle. In the transfer area, in the state where the toner particle contacts with the image carrier and does not contact with the transfer medium, in order to peel the toner particle from the image carrier, it is necessary to satisfy the relation of E>F₁/q (F₁ denotes the adhesion force between the toner particle and the image carrier). However, in the area where the toner particle contacts with the transfer medium as well, since the adhesion force F₂ is generated also between the toner particle and the transfer medium, the toner can be transferred from the image carrier to the transfer medium by the electric field of E>(F₁−F₂). The adhesion force F measured in the example of the invention is the adhesion force F₁ of the toner to the image carrier. Since a time between the contact and the end of the transfer process is very short, the magnitude of a generated mirror image electric charge relates to a time constant, and when it is assumed that the value of F₂ can be estimated to be about half of the magnitude of F₁, the following relation is established.

Ebk>E>(F₁/2)/q (A)

The particle size distribution inevitably exists in toner particles, and further, a distribution exists also in the charge amount. Here, when the charge amount distribution of the toner particle is examined, it is understood that the minimum electric charge amount [C per particle] of the toner particle existing in the developer sufficiently charged so as not to generate toner sputtering or fogging to a non-image part is set to be about q=4.5×10⁻¹⁶ [C] or more. Accordingly, when the value of the minimum electric charge amount of the toner particle is substituted into the expression (A), it is understood that F₀ is required to be 4×10⁻⁸ [N] or less.

Further, it is necessary that the proportional constant K of the square of the charge amount q is 0<K<2×10²².

Since it is indicated that as the charge amount becomes high, the electrostatic adhesion force becomes small, it can not theoretically occur that the value of K becomes 0 or less.

Besides, when K is larger than 2×10²², there occurs a state where the electric charge locally exists in the vicinity of the particle outermost surface although the variation of characteristic of the whole developer is low, or a state where the toner having high adhesion force is mixed so that the characteristic varies and the electric charge locally exists. In such characteristic, the electric field capable of transferring the particle having high charge amount contained in the toner can not be applied, and the transfer residual ratio becomes large.

This point will be described specifically. When the value of the slope K is large, it is indicated that when the charge amount of the toner is changed, the change amount of the magnitude of the required transfer electric field becomes large. Here, in F=K×q²+F₀ representing the relation between the adhesion force F and the square of the charge amount, when F₀ is very small, F₀ can be regarded as almost zero. Accordingly, when the influence of F₂ is also considered similarly to F₀, the following relation can be indicated.

Ebk>E>(K×q)/2 (B)

When the actual charge amount distribution of the toner particle is examined, the maximum charge amount [C per particle] of the toner particle existing in the developer charged so that a desired amount of toner can be developed under the condition that carrier adhesion does not occur is almost q=4.5×10¹⁵ [C] or less. When the maximum electric charge amount of the toner particle is substituted in expression (B), it is calculated that K is required to be 2×10²² [N/C²] or less.

The developer of the embodiment includes the magnetic material and the toner particle which is charged by the magnetic material and satisfies the relation described above.

The toner particle includes a binder resin (polyester resin, styrene-acrylic resin, cyclic olefin resin, etc.), a coloring agent (well-known pigment such as carbon black, condensed polycyclic pigment, azo pigment, phthalocyanine pigment or inorganic pigment, dye, etc.), wax (polyethylene system, synthetic wax of polypropylene fatty acid ester, paraffin system, microcrystalline oil wax, rice wax, plant wax such as carnauba wax), charge control agent (CCA) and the like. Besides, the toner particle has a well-known composition in which a fluidity improving inorganic fine particle (silica, alumina, titanium oxide, etc.), a fluidity improving organic fine particle or the like is externally added, and is produced by a pulverization or chemical production method. A volume average particle size is 3 to 8 μm, and is more preferably 4 to 6 μm.

The magnetic particle (carrier) can be made a well-known one such as a resin particle in which ferrite, magnetite, iron oxide, and magnetic powder are mixed. Besides, a resin coat (fluorine resin, silicone resin, acrylic resin, etc.) may be applied to the whole or part of the surface of the magnetic particle. The volume average particle size of the magnetic particle is 20 to 100 μm, and is more preferably 30 to 60 μm. The other structure can also be changed within the scope not departing from the gist of the invention.

Here, a method of adjusting the toner particle so that the values of K and F₀ satisfy the above-described relation is not particularly limited, and can be suitably selected by a skilled person in the art.

As a method of adjusting the value of K, for example, an exposure component of a toner surface is uniformed or uniformly dispersed. Specifically, a method, such as improving the dispersion of a pigment, reducing the dispersion particle size of wax to prevent exposure to the surface, or covering the surface of a mother particle with resin for encapsulation, is exemplified. Besides, uniformly dispersing an external additive without localization can also be mentioned as one of the methods of adjusting the value of K.

On the other hand, as a method of adjusting the value of F₀, reducing the dispersion particle size of wax to prevent exposure to the surface, adhering a fine particle to the toner surface to reduce the contact area with the image carrier, eliminating particles of shapes close to a rectangle rather than a sphere among indefinite-shape particles, or the like is exemplified.

Further, in order to realize such adhesion force characteristic that data (plot) of the adhesion force of particles different in particle size and the charge amount are positioned closely to the straight line of F=K×q²+F₀, a measure can be taken such that the variation in shape is suppressed, the content rate of components is not much changed according to the particle, or the exposure component of the toner surface is uniformed or uniformly dispersed.

The developer of the embodiment as stated above is used, and the toner image is formed by, for example, an electrophotographic process as described below.

### (Toner Image Formation Using an Image Forming Apparatus Based on a Two-Component Development Process)

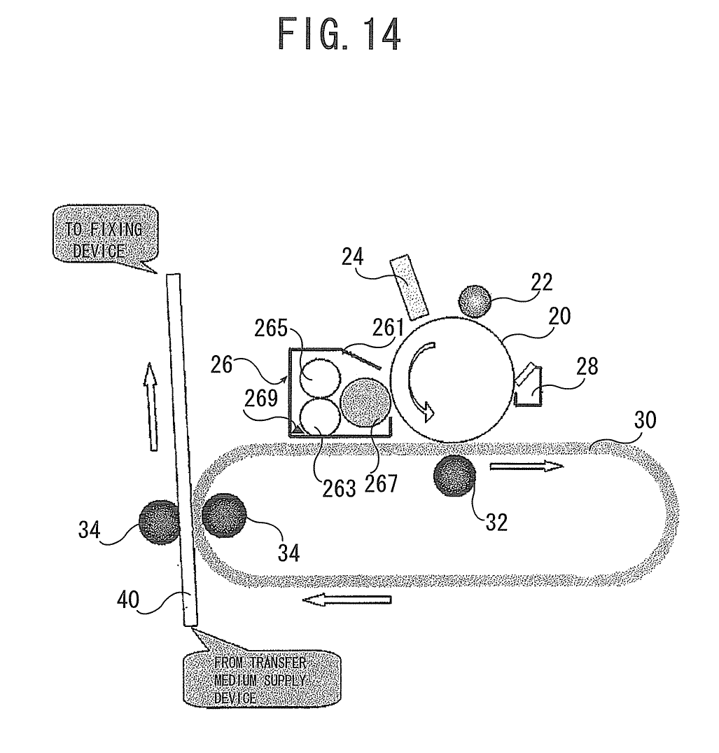

FIG. 14 is a schematic view of an image forming apparatus using a two-component development process and relating to toner image formation. As shown in FIG. 14, the image forming apparatus includes an electrostatic latent image carrier (image carrier) 20 on which an electrostatic latent image is formed, a charging device 22 to charge the image carrier 20, an exposure device 24 to form the electrostatic latent image on the image carrier 20, a developing device 26 (equivalent to a developer containing section and a developing section) to supply a toner particle to the electrostatic latent image on the image carrier 20, an image carrier cleaning device 28 (hereinafter referred to as a cleaning device 28) to remove toner (transfer residual toner) remaining on the image carrier, an intermediate transfer medium 30 to which a toner image formed by the developing device 26 is transferred, a primary transfer member 32 to transfer the toner image to the intermediate transfer medium 30 from the image carrier 20, and a secondary transfer member 34 to transfer the toner image, which was transferred by the primary transfer member 32 to the intermediate transfer medium 30, to a sheet 40 as a final transfer medium.

The electrostatic latent image carrier (image carrier) 20 can be made of a well-known photoreceptor such a positively charged or negatively charged OPC, or amorphous silicon. A charge generation layer, a charge transport layer, a protective layer and the like may be laminated, or one layer may have plural functions.

Besides, the charging device 22 may be a well-known one, and for example, a corona charger (charger wire, comb charger, scorotron, etc.) as a non-contact charging device, a non-contact charging roller, a contact charging roller as a contact charging device, a magnetic brush, a conductive brush, a solid charger, or the like can be used.

The exposure device 24 may also be a well-known one, and a laser, an LED, a solid head or the line can be named.

The developing device 26 includes a developer container 261, agitating augers 263 and 265, and a developing roller 267. A not-shown hopper is coupled to the developer container 261. The hopper contains a replenishing developer (a toner particle or a toner particle plus a slight amount of magnetic particle) of, for example, 50 g to 500 g, and the developer container 261 contains the developer of the embodiment, which includes the magnetic material and the toner particle, of, for example, 100 g to 700 g. The developer is conveyed to the developing roller 267 containing a mag roller by the agitating augers 263 and 265. The electrostatic latent image is developed by the magnetic brush development in which the charged toner particle is supplied and adhered to the electrostatic latent image on the image carrier 20 from the developing roller 267. At this time, a development bias is applied to the developing roller 267 in order to form an electric field to adhere the toner to the electrostatic latent image. In the development bias, AC may be superimposed on DC so that the toner particle is uniformly and stably adhered to the surface of the photoreceptor.

A part of toner is lost by the development, and then, the toner is separated from the developing roller 267 at a peeling pole position of the mag roller, and is returned into the developer container 261 by the agitating augers 263 and 265. A well-known toner density sensor 269 can be set in the developer container 261. When the toner density sensor 269 detects the reduction of the toner amount, a signal is sent to the hopper, and new (non-used) toner is supplied to the developer container. Besides, toner consumption is estimated from the accumulation of print data and/or the detection of the amount of developer on the photoreceptor, and new toner may be supplied based on that. Besides, both the sensor output and the estimation of the consumption may be used. Differently from the conception of supplying a consumed amount of toner, in order to keep the amount of toner developed at a specified development contrast, when the toner development amount is decreased because of the increase of the toner charge amount or the like, new toner may be supplied to restore the toner development amount and to keep the picture quality. A system may also be adopted in which simultaneously with the new toner or separately therefrom, a new carrier is supplied little by little, and the developer is discarded little by little, so that the developer is automatically exchanged.

The intermediate transfer medium 30 may be a well-known transfer belt or transfer roller. In the case of the transfer belt, its material is rubber such as EPDM or CR rubber, or resin such as polyimide, polycarbonate, PVDF or ETFE. The surface protective layer of the intermediate transfer belt may include one layer or two or more laminated layers. The volume resistance of the transfer belt is desirably 10⁷ Ωcm to 10¹² Ωcm. Besides, the surface resistance of the transfer belt can be made 10⁷ Ωcm to 10¹² Ωcm, and is, for example, 10⁹ Ωcm. Other structures may be adopted within the scope not departing from the gist of the invention.

Each of the primary transfer member 32 and the secondary transfer member 34 may be a well-known one such as a transfer roller, a transfer blade, or a corona charger like.

The cleaning device 28 removes the transfer residual toner remaining on the image carrier 20 after the toner image is transferred to the intermediate transfer medium 30. The transfer residual toner removed by the cleaning device 28 is sent to a conveyance path (not shown) by the auger and the like (not shown), and is stored in a waste toner box (not shown), and then is discharged. Alternatively, the residual toner is collected from the conveyance path into a developer container of the developing device (recycle system). Incidentally, the electrostatic latent image on the image carrier is erased by a not-shown charge-removal device.

The image forming apparatus as stated above is used and the toner image is formed on the sheet 40 by the following process.

First, the electrostatic latent image carrier 20 is uniformly charged to a desired potential by the charging device 22. Next, an electrostatic latent image is formed on the electrostatic latent image carrier 20 by the exposure device 24. Next, a charged toner particle is supplied from the developing device 26 to the electrostatic latent image, and develops the latent image (formation of a toner image). The formed toner image is transferred by the primary transfer member 32 from the electrostatic latent image carrier 20 to the intermediate transfer medium 30. Next, the toner image transferred to the intermediate transfer medium 30 is transferred by the secondary transfer member 34 from the intermediate transfer medium 30 to the sheet 40.

The toner image transferred to the sheet 40 is sent to a not-shown fixing unit (well-known heating and pressing unit such as a heat roller), is heated and pressed, and is fixed. Besides, the transfer residual toner on the image carrier 20 is removed by the cleaning device 28 from the image carrier 20.

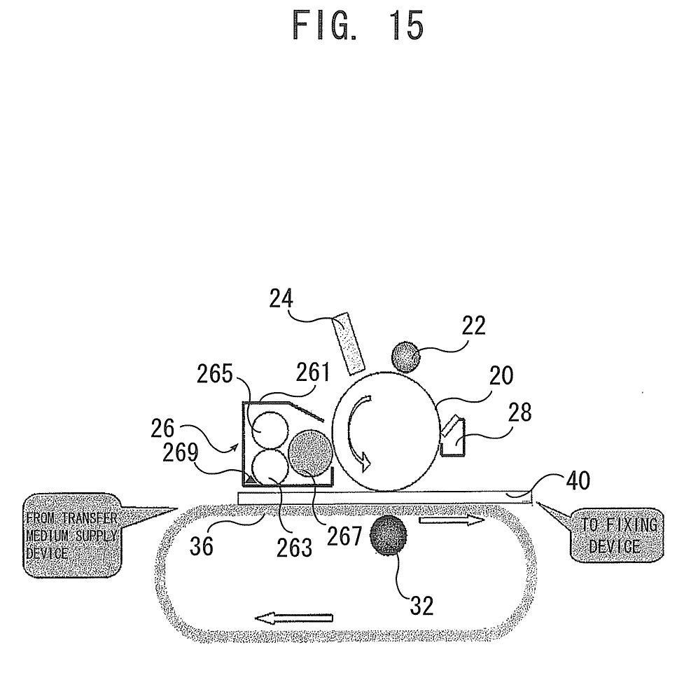

Incidentally, in the above, although the description is made on the image forming apparatus including the intermediate transfer medium 30, as shown in FIG. 15, naturally, the image forming apparatus may also have such a structure that a toner image is directly transferred from an image carrier 20 by a transfer member 38 to a sheet 40 conveyed by a transfer conveyance medium 36.

### (Toner Image Formation Process by a Cleanerless System Image Forming Apparatus)

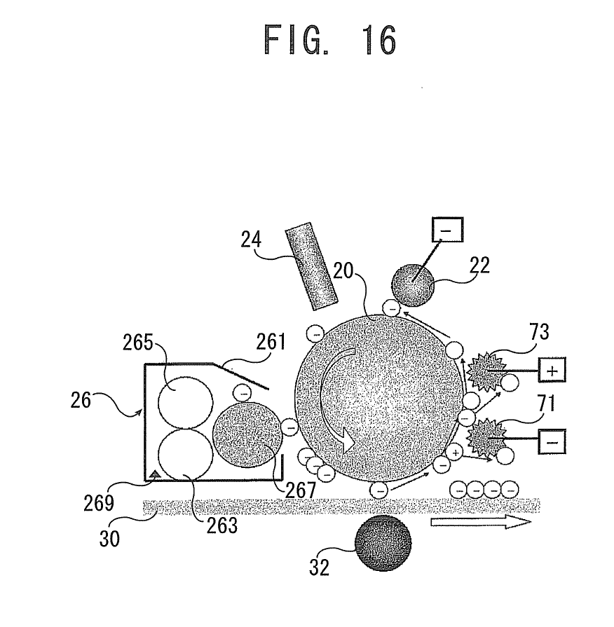

The cleanerless system image forming apparatus in which the developer of the embodiment is contained in a developing device can also be adopted. In the cleanerless system image forming apparatus, an image is formed by the image forming apparatus similar to the two-component development process and by the similar process. However, as shown in FIG. 16, a difference exists in that the cleaner device 28 does not exist. The transfer residual toner on an image carrier 20 is collected into a developing device 26 without using the cleaner device 28. In other words, the developing device 26 adheres toner to an electrostatic latent image formed on the image carrier 20 to develop the electrostatic latent image and forms the toner image on the image carrier 20, and further collects the toner particle remaining on the image carrier 20.

The collection of the transfer residual toner will be specifically described. First, after the image carrier 20 is charged and exposed, the developing device 26 forms a toner image with a developer, and the toner image is transferred to an intermediate transfer medium 30 or is directly transferred to the sheet 40. Thereafter, the toner remaining on the image carrier 20 is again conveyed to the development area through processes of charge removal, charging and exposure, and is collected into the developing device 26 by a magnetic brush which is a developer carrier 261.

Hereinafter, the cleanerless system image forming apparatus and an image forming process using the image forming apparatus will be described. However, a component described in the two-component image forming process is denoted by the same reference numeral and its description is omitted.

In the cleanerless system image forming apparatus, a memory disturbance member such as a fixed brush, a felt, a rotating brush, or a side sliding brush may be disposed in order to perform charge removal, charging and exposure processes before or after the removal of the electrostatic latent image on the image carrier 20. Besides, a temporal collection member may be disposed to temporarily collect the remaining toner and to again discharge it onto the image carrier in order to cause the developing device to collect it. Further, a toner charging device may be provided on the photoreceptor in order to adjust the charge amount of the remaining toner to a desired value. With respect to the toner charging device, the memory disturbance member, the temporal collection member and the charging member 22, a part of or all of the processes may be performed by one member. Besides, in order to efficiently perform the function, plus and/or minus DC and/or AC voltage may be applied to these members.

FIG. 16 shows an example in which the three processes of memory disturbance, temporal collection, and toner charging are performed. In FIG. 16, two side sliding brushes 71 and 73 are provided between a transfer area and a charging member 22 in such a form that brush ends contact with the image carrier 20. The voltage of the same polarity as the electric charge of development toner is applied to the upstream brush 71 and the voltage of different polarity from the electric charge of development toner is applied to the downstream brush 73. The different polarity toner and the same polarity toner having very high electric charge are mixed in the transfer residual toner. When the different polarity toner contacts with the same polarity brush 71, the electric charge is reversed and the toner passes through or is once collected by the brush 71. All of the transfer residual toner which reaches the downstream different polarity brush 73 is adjusted to the same polarity as the development toner. When the toner contacts with the different polarity brush 73, the high same polarity electric charge is relaxed, and the toner passes through or is once collected by the brush 73. The transfer residual toner which is adjusted to the weak charge amount and in which the image structure is lost by the mechanical contact of the brush is charged, together with the image carrier 20, by the contact or non-contact charging member 22, and is adjusted to the same degree of charge amount as the development toner. By this, the transfer residual toner is collected into the developing device 26, and is, together with the toner newly supplied from the developing device, transferred to the intermediate transfer medium 30.

### (Image Forming Process Using a Four-Tandem Type Image Forming Apparatus)

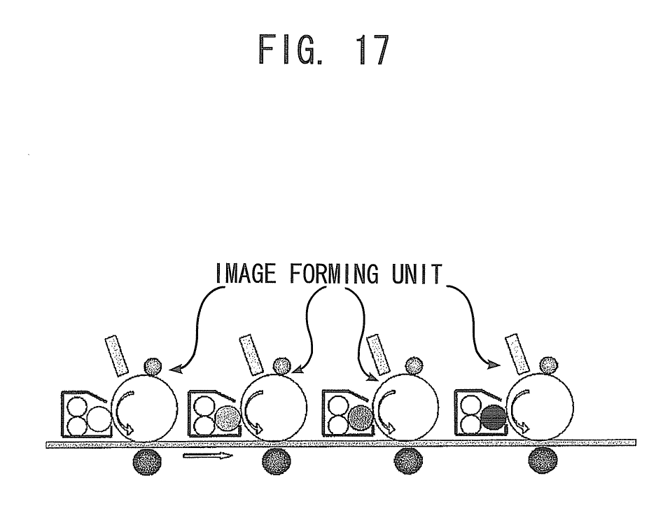

As shown in FIG. 17, a tandem color image forming apparatus can also be naturally adopted in which four image forming units each including a developing device storing a toner of each color of yellow, magenta, cyan and black, an image carrier, a charging member, an exposure member and a transfer member are provided for the four colors, and are arranged in series along a conveyance path of a transfer medium. Also in the tandem type image forming apparatus, the transfer may be directly performed to the transfer medium, or may be performed through an intermediate transfer medium. For example, a case where the image forming units are arranged in the order of yellow, magenta, cyan and black will be described. Incidentally, with respect to the respective components of the image forming unit and the toner image forming process in each of the image forming units, since the description of the two-component image forming process can be applied, their description is omitted.

First, in the yellow image forming unit, a yellow toner image is formed on the photoreceptor and is transferred to the transfer medium. In the case of the direct transfer, the sheet 40 as the final transfer medium is conveyed by a conveyance member such as a transfer belt or a roller and is supplied to the transfer area of the yellow image unit.

Next, in the magenta image forming unit, a magenta toner image is similarly formed on the photoreceptor. The transfer medium on which the yellow toner image is already transferred is supplied to the transfer area of the magenta image forming unit, and the magenta toner image is registered with and transferred onto the yellow toner image. At this time, the yellow toner on the transfer medium contacts with the magenta photoreceptor, and there is a fear that a very small part of the yellow toner is reversely transferred to the magenta photoreceptor according to the toner charge amount and the magnitude of transfer electric field. However, when the toner particle of this embodiment is used, the reverse transfer hardly occurs although a slight difference occurs according to the user state.

Next, toner images are similarly formed also in the cyan and black image forming units, and are sequentially overlappingly transferred onto the transfer medium. Although there is a possibility that a very small part of the former toner (yellow and magenta toners to the cyan photoreceptor, yellow, magenta and cyan toners to the black photoreceptor) is reversely transferred also to each of the cyan and black photoreceptors, as stated above, when the toner particle of this embodiment is used, the reverse transfer hardly occurs.

When the transfer medium on which the four color toners are overlapped is the final transfer medium, the transfer medium is peeled off from the conveyance member, is conveyed to the fixing unit, and is discharged to the outside of the machine after fixing is performed by a well-known heating and pressing system such as a heat roller. In the case of an intermediate transfer medium, the toner images of four colors are collectively transferred to a sheet supplied by a secondary transfer unit, and then are conveyed to a fixing unit, are similarly fixed, and are discharged to the outside of the machine.

Incidentally, in each of the image forming units, as described in the two-component image forming process, the photoreceptor is again returned to the image forming process through charge removal, cleaning and the like. Besides, the toner ratio density is adjusted in the developing device as the need arises. Here, although the example is described in which the image forming units are arranged in the order of yellow, magenta, cyan and black, the order of the colors is not limited.

### (Image Forming Process of a Four-Tandem Type Image Forming Apparatus Including a Cleanerless System)

The four-tandem type image forming apparatus including the developer of the embodiment can be constructed to further include a cleanerless system. In this case, specifically, one or plural image forming units do not include a cleaner device, and a developing device collects a toner particle simultaneously with the development.

As stated above, the charging amount of the toner remaining on the image carrier is adjusted and the toner is collected in the developing device. However, in the case of the four-tandem machine, when the toner of the former color is reversely transferred, the toner is also collected by the developing device. Thus, there is a problem that when the amount of reverse transfer is large, the hue of toner in the developing device is changed. However, when the developer of this embodiment is used, the amount of reverse transfer is suppressed to be very small, and accordingly, the problem of the mixed color hardly occurs. Besides, simultaneously, when the remaining transfer amount and the reverse transfer amount are large, the amount of toner temporarily collected by the memory disturbance brush becomes large, and there is a fear that the discharge process from the brush is required frequently and strongly, and a specified function can not be performed. However, when the developer of the embodiment is used, since the remaining transfer amount and the reverse transfer amount can be made very small, the amount of toner temporarily collected by the memory disturbance brush is small, the discharge from the brush is easy, and the cleanerless process can be kept while the high quality is kept for a long period.

Hereinafter, the invention will be described while using examples. However, the examples are merely examples and do not restrict the invention.

### (Production of the Developer)

First, the toner particle contained in the developer is produced.

(Toner Particle Included in after-Mentioned Example 1 and Example 2)

A pigment, multivalent carboxylic acid, and polyalcohol are dispersed in an organic solvent, and is converted into micelle form in an aqueous solvent, and a polyester resin fine particle is synthesized in which the pigment is dispersed by a dehydrating and condensing reaction. Emulsion dispersed paraffin system synthetic wax, multivalent carboxylic acid and polyalcohol are further added thereto, the wax component is adsorbed to the coloring resin particle by stirring and heating and is grown to a desired particle size. The dispersed fine particle is added to an organic solvent in which silica (surface treated by dimethyldichlorosilane. 1.5 wt) having a primary particle size of 12 nm and titanium oxide (1.0 wt %) having a primary particle size of 14 nm are dispersed, is agitated and is filtered, so that a silica particle and a titanium oxide particle are uniformly adhered to the surface of the coloring resin particle. The particle dispersed liquid is heated, and is dried while high stress is applied. As a result, a polyester resin particle is obtained in which the wax and the pigment are included, silica and titanium oxide are adhered to the outer shell, and the shape is changed. Thereafter, silica (1.2 wt) having a primary particle size of 100 nm is externally added by a Henschel mixer, so that the toner particle is obtained in which 50% volume average particle size is 5.0 μm, and the ratio to 50% number average particle size is (D50vol)/(D50pop)=1.11. In this toner, since the pigment, together with monomer, is dispersed in the solution, uniform dispersion is excellent. Since wax has a suitable particle size and is dispersed in the particle, and a fine inorganic particle is also added in the solution. Thus, the toner particle is obtained in which the components are uniform, and both the charging characteristic and the adhesion characteristic are highly uniform. This toner particle is mixed with a carrier 1 at two kinds of ratios of T/D (toner density weight ratio)=6% and 10%, and two kinds of developers are prepared (examples 1 and 2).

Incidentally, the toner particle produced based on the method is called a chemical (1) in Table 1 described later.

### (Toner Particle Included in Comparative Example 1 Described Later)

Two kinds of polyester resins different in molecular weight, pigment, paraffin system synthetic wax, and CCA are kneaded, roughly pulverized, finely pulverized and classified, so that a mother particle is produced. Silica (surface treated with hexamethylsilazane. 2.5 wt %) having a primary particle size of 30 nm, titanium oxide (1 wt %) having a primary particle size of 25 nm, and silica (1.2 wt %) having a primary particle size of 100 nm are externally added thereto by the Henschel mixer, so that toner particle of 50% number average particle size of 6.3 μm is obtained. In this toner, since the wax component kneaded in the mother particle is partially exposed on the particle surface, the electric charge can not be uniformly dispersed on the surface, irregular particles have high adhesion force, and the transfer residual amount becomes large. This toner is mixed with a carrier 2 at a ratio of T/D=8.5%, and the developer is prepared (equivalent to comparative example 1).

In addition, toner particles are produced by the production method of the toner particle included in comparative example 1 described later and in accordance with the composition shown in Table 1. The toner particles produced based on the method are called pulverization C(1) to pulverization C(4), and pulverization M(5) to pulverization M(9) in Table 1.

Table 1 shows the compositions of the produced toners.

TABLE 1

| | | | | | | | | | TITANIUM | | PARTICLE |
|---|---|---|---|---|---|---|---|---|---|---|---|
| | PIGMENT | RESIN | CCA | WAX | SILICA 1 | | SILICA 2 | | OXIDE | | SIZE [μm] |
| CHEMICAL (1) | PHTHALOCYANINE | D | — | PARAFFIN | 12 | nm | 100 | nm | 14 | nm | 5.0 |
| | PIGMENT | | | SYSTEM | 1.5 | wt % | 1.2 | wt % | 1.0 | wt % | |
| PULVERIZATION | PHTHALOCYANINE | B | 1.0 wt % | — | 30 | nm | 100 | nm | 14 | nm | 7.0 |
| C(2) | PIGMENT | | | | 2.5 | wt % | 1.0 | wt % | 0.7 | wt % | |
| PULVERIZATION | PHTHALOCYANINE | B | 1.0 wt % | — | 30 | nm | 100 | nm | 14 | nm | 6.8 |
| C(3) | PIGMENT | | | | 2.5 | wt % | 1.0 | wt % | 0.7 | wt % | |
| PULVERIZATION | PHTHALOCYANINE | B | 1.0 wt % | PARAFFIN | 30 | nm | 100 | nm | 14 | nm | 6.9 |
| C(4) | PIGMENT | | | SYSTEM | 2.5 | wt % | 1.0 | wt % | 0.7 | wt % | |
| PULVERIZATION | PHTHALOCYANINE | A | 1.0 wt % | PARAFFIN | 30 | nm | 100 | nm | 14 | nm | 7.1 |
| C(1) | PIGMENT | | | SYSTEM | 2.5 | wt % | 1.0 | wt % | 0.7 | wt % | |
| PULVERIZATION | AZO PIGMENT | A | 1.0 wt % | PARAFFIN | 30 | nm | 100 | nm | 14 | nm | 7.1 |
| M(5) | | | | SYSTEM | 2.5 | wt % | 1.0 | wt % | 0.7 | wt % | |
| PULVERIZATION | AZO PIGMENT | A | 1.5 wt % | PARAFFIN | 30 | nm | 100 | nm | 14 | nm | 6.9 |
| M(6) | | | | SYSTEM | 2.8 | wt % | 1.0 | wt % | 1.1 | wt % | |
| PULVERIZATION | AZO PIGMENT | C | 1.0 wt % | PARAFFIN | 12 | nm | — | | 14 | nm | 5.2 |
| M(7) | | | | SYSTEM | 1.5 | wt % | | | 1.0 | wt % | |
| PULVERIZATION | AZO PIGMENT | C | 1.0 wt % | PARAFFIN | 12 | nm | 100 | nm | 14 | nm | 5.2 |
| M(8) | | | | SYSTEM | 1.5 | wt % | 1.2 | wt % | 1.0 | wt % | |
| PULVERIZATION | AZO PIGMENT | C | 1.0 wt % | PARAFFIN | 12 | nm | 100 | nm | 14 | nm | 5.3 |
| M(9) | | | | SYSTEM | 1.5 | wt % | 1.2 | wt % | 1.0 | wt % | |

The characteristics of the resins A to C used in the production of the toner are as shown in Table 2. In polyester resin, the molecular weight and cross-link point are adjusted and the resins synthesized so as to have Tg and softening point as shown in the Table are used. Besides, the four kinds of resins are synthesized to have almost the same molecular weight distribution.

TABLE 2

| | Tg | SOFTENING POINT |
|---|---|---|
| RESIN A | 56.5 TO 60.5 | 106 TO 120 |
| RESIN B | 61.5 OR MORE | 106 TO 120 |
| RESIN C | 60.5 OR MORE | 124 TO 130 |

| | |
|---|---|
| RESIN D | MEASUREMENT FOR |
| | SINGLE RESIN IS IMPOSSIBLE |

### (Production of Developer)

A magnetic material is mixed with the produced toner particle shown in Table 1 at a mixing ratio (weight ratio) in accordance with the numeral of T/D and the developer is produced.

Table 3 shows the list of produced developers. Besides, Table 3 shows also the transfer residual ratio, the proportional constant of the square of the charge amount q and the non-electrostatic charge amount F₀ of the toner particle included in the produced developer.

TABLE 3

| | | | | TRANSFER | | |
|---|---|---|---|---|---|---|
| | | | | RESIDUAL | | |
| DEVELOPER | TONER | CARRIER | T/D | RATIO | K[N/C²] | F₀[N] |
| EXAMPLE 1 | CHEMICAL (1) | 1 | 10% | 0.009 | 7.75E+21 | 1.25E−08 |
| EXAMPLE 2 | CHEMICAL (1) | 1 | 6% | 0.019 | 9.87E+21 | 5.15E−09 |
| EXAMPLE 3 | PULVERIZATION C(2) | 4 | 7% | 0.05 | 1.29E+22 | 1.04E−08 |
| EXAMPLE 4 | PULVERIZATION C(3) | 2 | 9% | 0.017 | 9.59E+21 | 5.09E−09 |
| EXAMPLE 5 | PULVERIZATION C(4) | 1 | 7% | 0.041 | 4.43E+21 | 2.81E−08 |
| EXAMPLE 6 | PULVERIZATION C(4) | 4 | 7% | 0.035 | 3.30E+21 | 3.26E−08 |
| EXAMPLE 7 | PULVERIZATION M(6) | 2 | 8.5% | 0.047 | 5.03E+21 | 6.11E−09 |
| COMPARATIVE | PULVERIZATION C(1) | 2 | 8.5% | 0.153 | 7.87E+21 | 3.39E−08 |
| EXAMPLE 1 | | | | | | |
| COMPARATIVE | PULVERIZATION M(5) | 2 | 8.5% | 0.124 | 9.07E+21 | 2.68E−08 |
| EXAMPLE 2 | | | | | | |
| COMPARATIVE | PULVERIZATION C(2) | 1 | 7% | 0.088 | 1.80E+22 | 2.20E−08 |
| EXAMPLE 3 | | | | | | |
| COMPARATIVE | PULVERIZATION C(4) | 2 | 7% | 0.148 | 1.01E+22 | 2.36E−08 |
| EXAMPLE 4 | | | | | | |
| COMPARATIVE | PULVERIZATION M(7) | 3 | 7% | 0.215 | 1.65E+22 | 3.97E−08 |
| EXAMPLE 5 | | | | | | |
| COMPARATIVE | PULVERIZATION M(8) | 3 | 7% | 0.146 | 1.41E+22 | 1.56E−08 |
| EXAMPLE 6 | | | | | | |
| COMPARATIVE | PULVERIZATION M(9) | 1 | 8.5% | 0.281 | 3.64E+22 | 2.74E−08 |
| EXAMPLE 7 | | | | | | |
| COMPARATIVE | PULVERIZATION M(9) | 1 | 6% | 0.367 | 3.70E+22 | 0.00E−00 |
| EXAMPLE 8 | | | | | | |

The transfer residual ratio is obtained in such a manner that toner is loaded in MFP (FC-3510C) made by Toshiba, a filled-in image of toner of about 500 μg/cm² is developed on a photoreceptor, the amount of transfer residual toner particle on the photoreceptor is measured when a transfer bias, by which the transfer ratio becomes highest at the transfer to an intermediate transfer belt, is applied, and the ratio to the development amount is calculated.

The adhesion force F and the proportional constant K of the square of the charge amount q are obtained by calculating the linear approximate expression representing the relation of these as described above.

Table 4 shows the list of mixed magnetic materials, the coat amount of these magnetic materials, CCA disperse amount and measurement results of toner charge amount measured by using Black toner (minus charged) loaded in the MFP (FC-3510C) made by Toshiba and based on the toner charge amount measurement method standard recommended by Imaging Society of Japan. In the magnetic material, a resin coat is applied to a ferrite particle of average particle size of 40 μm, and in the coat resin, positively charged CCA is dispersed in order to raise the effect of negatively charging the toner.

TABLE 4

| | | | CCA | TONER |
|---|---|---|---|---|
| | | COAT | ADDITION | CHARGING |
| CARRIER | COAT RESIN | AMOUNT | AMOUNT | AMOUNT |
| 1 | ACRYL SILICONE | 5 wt % | 6 wt % | −53.5 uC/g |
| | RESIN | | | |
| 2 | SILICONE RESIN | 8 wt % | 5 wt % | −38.7 uC/g |
| 3 | SILICONE RESIN | 8 wt % | 6.5 wt % | −41.2 uC/g |
| 4 | SILICONE RESIN | 8 wt % | 8 wt % | −45.5 uC/g |

Although the invention is described up to now, the invention is not limited to this, and another embodiment can also be used.

For example, in the embodiment, 10%, 50% and 90% are extracted from the particle size distribution represented by the number frequency, the adhesion force F and the square of the charge amount q are correlated, and F=K×q²+F₀ of the linear function approximate expression is obtained. However, no limitation is made to this, and another particle shape is extracted and the linear function approximate expression may be obtained.

Although the invention is described in detail while the specific embodiment is used, it would be obvious for one of ordinary skill in the art that various modifications and alterations can be made without departing from the sprit and the scope of the invention.

According to the invention, since the transfer residual ratio of the toner particle to the image carrier is made small, for example, 5% or less, the occurrence of reverse transfer or the like can be reduced significantly.

What is claimed is:

1. A developer comprising a magnetic particle, and a toner particle charged by the magnetic particle, wherein
when a relation between an adhesion force F of the toner particle to an image carrier of an image forming apparatus and a square of a charge amount q of the toner particle is represented by a linear function approximate expression of F=K×q²+F₀ based on a particle size distribution of the toner particle, a value of a proportional constant K of the square of the charge amount q of the toner particle and a value of a non-electrostatic adhesion force F₀ satisfy a following relation:
0<K≦2×10²² i)
0<F₀≦4.0×10⁻⁸ ii)
K<−5×10²⁹×F₀+2×10²². iii)

2. The developer of claim 1, wherein
the particle size distribution of the toner particle is the particle size distribution expressed by a number frequency, and
the linear function approximate expression of F=K×q²+F₀ is calculated from a value of the adhesion force F of the toner particle and a value of the square of the charge amount q of the toner particle, which are correlated based on the particle size distribution expressed by the number frequency, a distribution of the adhesion force F expressed by an accumulated weight ratio with respect to a plurality of particle sizes extracted from the particle size distribution expressed by the number frequency, and a distribution of the square of the charge amount expressed by the accumulated weight ratio.

3. The developer of claim 2, wherein
the plurality of particle sizes extracted from the particle size distribution expressed by the number frequency are the particle sizes in which the number frequency is expressed by 10%, 50% and 90%.

4. An image forming apparatus comprising:
an image carrier on which an electrostatic latent image is formed;
a developer containing section to contain a developer having a toner particle in which when a relation between an adhesion force F to the image carrier and a square of a charge amount q is represented by a linear function approximate expression of F=K×q²+F₀ based on a particle size distribution, a value of a proportional constant K of the square of the charge amount q of the toner particle and a value of a non-electrostatic adhesion force F₀ satisfy a following relation, and a magnetic particle to charge the toner particle; and
a developing section which causes the toner particle of the developer contained in the developer containing section to adhere to the electrostatic latent image formed on the image carrier, and develops the electrostatic latent image to form a toner image on the image carrier:
0<K≦2×10²² i)
0<F₀≦4.0×10⁻⁸ ii)
K<−5×10²⁹×F₀+2×10²². iii)

5. The apparatus of claim 4, wherein
the particle size distribution of the toner particle is the particle size distribution expressed by a number frequency, and
the linear function approximate expression of F=K×q²+F₀ is calculated from a value of the adhesion force F of the toner particle and a value of the square of the charge amount q of the toner particle, which are correlated based on the particle size distribution expressed by the number frequency, a distribution of the adhesion force F expressed by an accumulated weight ratio with respect to a plurality of particle sizes extracted from the particle size distribution expressed by the number frequency, and a distribution of the square of the charge amount expressed by the accumulated weight ratio.

6. The apparatus of claim 5, wherein
the plurality of particle sizes extracted from the particle size distribution expressed by the number frequency are the particle sizes in which the number frequency is expressed by 10%, 50%, and 90%.

7. The apparatus of claim 4, wherein
the developing section causes the toner particle of the developer contained in the developer containing section to adhere to the electrostatic latent image formed on the image carrier and develops the electrostatic latent image to form the toner image on the image carrier, and collects a toner particle remaining on the image carrier.

8. An image forming method comprising:
causing a photoreceptor or a conveyance medium to support a toner particle in which when a relation between an adhesion force F of the toner particle to an image carrier of an image forming apparatus and a square of a charge amount q of the toner particle is represented by a linear function approximate expression of F=K×q²+F₀ based on a particle size distribution, a value of a proportional constant K of the square of the charge amount q of the toner particle and a value of a non-electrostatic adhesion force F₀ satisfy a following relation; and
forming an image by transferring the toner particle supported on the photoreceptor or the conveyance medium onto a sheet:
0<K≦2×10²² i)
0<F₀≦4.0×10⁻⁸ ii)
K<−5×10²⁹×F₀+2×10²². iii)

9. The method of claim 8, wherein
the particle size distribution of the toner particle is the particle size distribution expressed by a number frequency, and
the linear function approximate expression of F=K×q²+F₀ is calculated from a value of the adhesion force F of the toner particle and a value of the square of the charge amount q of the toner particle, which are correlated based on the particle size distribution expressed by the number frequency, a distribution of the adhesion force F expressed by an accumulated weight ratio with respect to a plurality of particle sizes extracted from the particle size distribution expressed by the number frequency, and a distribution of the square of the charge amount expressed by the accumulated weight ratio.

10. The method of claim 9, wherein
the plurality of particle sizes extracted from the particle size distribution expressed by the number frequency are the particle sizes in which the number frequency is expressed by 10%, 50% and 90%.
